(19) United States
(12) Patent Application Publication
(10) Pub. No.: US 2002/0095431 A1
(43) Pub. Date: Jul. 18, 2002

(54) Generic system and method for collecting survey data

(76) Inventors: Vernon E. Mc George JR., San Jose, CA (US); Scott Cressler, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 09/765,881

(22) Filed: Jan. 16, 2001

(51) Int. Cl. G06F 17/30

(52) U.S. Cl. 707/200; 707/1

(57) ABSTRACT

A survey data collection system and method wherein a question to be presented in a survey is assigned a unique identification code. Relevant potential answers to the question are each assigned unique answer codes. A question choice record is created to associate the unique identification code assigned to the question with the answer codes assigned to each of the relevant potential answers. Based upon the question choice record, each time the question is presented to a survey participant, the relevant answers associated with the question via the question choice record will be presented as potential answers to the presented question.

### TECHNICAL FIELD

The present invention is generally related to a system and method for collecting survey data and incorporating the collected data into a database and, more particularly, is related to a system and method for collecting survey data and updating a database in accordance with a choice record generated in response to a survey participant's completion of a survey question.

### BACKGROUND OF THE INVENTION

It is common for individuals and organizations to collect a broad range of information by soliciting answers to predetermined survey questions. Typical survey formats provide for specific predetermined answers which can be selected by a survey participant in response to the particular question presented.

These surveys are often presented via a graphical user interface (GUI) of a computer system. With such a system, a respondent will typically provide a response to a particular survey question via selecting an answer from a predetermined selection of answer choices. The respondent's answer choices are then typically submitted for incorporation into a database. Typical survey data collection systems must be revised/changed each time, for example, additional or new answer choices are to be implemented. Further, where additional or new questions are to be incorporated, significant changes in the structure of the survey forms and database are required.

Thus, a heretofore unaddressed need exists in the industry to address the aforementioned deficiencies and inadequacies.

### SUMMARY OF THE INVENTION

The present invention provides a system and method for collecting survey data and storing it in an associated survey database.

Briefly described, in architecture, the system can be implemented as follows. There is provided a database server that includes a database for storing survey data. An interface for receiving an answer record from a client-side workstation is provided. A controller controls updating the database in accordance with the answer record.

The present invention can also be viewed as providing a method for collecting survey data. In this regard, the method can be broadly summarized by the following steps: assigning a question code to a question to be presented in a survey; assigning an answer code to each of a plurality of potential answers to the question; creating a question choice record for associating the question code with each of the assigned answer codes; presenting the question to a survey participant; and, presenting the set of potential answers to the survey participant in accordance with the question choice record.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is an illustration of one embodiment of a survey data collection system;

FIG. 2 is an illustration of a question table 50;

FIG. 3 is an illustration of an answer table 60;

FIG. 4 is an illustration of question choice set records 110C-110D which associate a question ID with various answer IDs;

FIG. 5 is a flowchart illustrating the method of the present invention;

FIG. 6A is an illustration depicting one example of a GUI presenting a survey form;

FIG. 6B is an illustration depicting a further example of a GUI presenting a survey form;

FIG. 7 is an illustration of a choice record 120 that associates a question ID with an answer ID;

FIG. 8 is a block diagram illustrating an embodiment of a database server 250;

FIG. 9 is a block diagram illustrating an embodiment of a client-side terminal 150; and

FIG. 10 is a block diagram illustrating an embodiment of the survey data collection system of the present invention.

### DETAILED DESCRIPTION OF THE PREFERRED EMBODIMENT

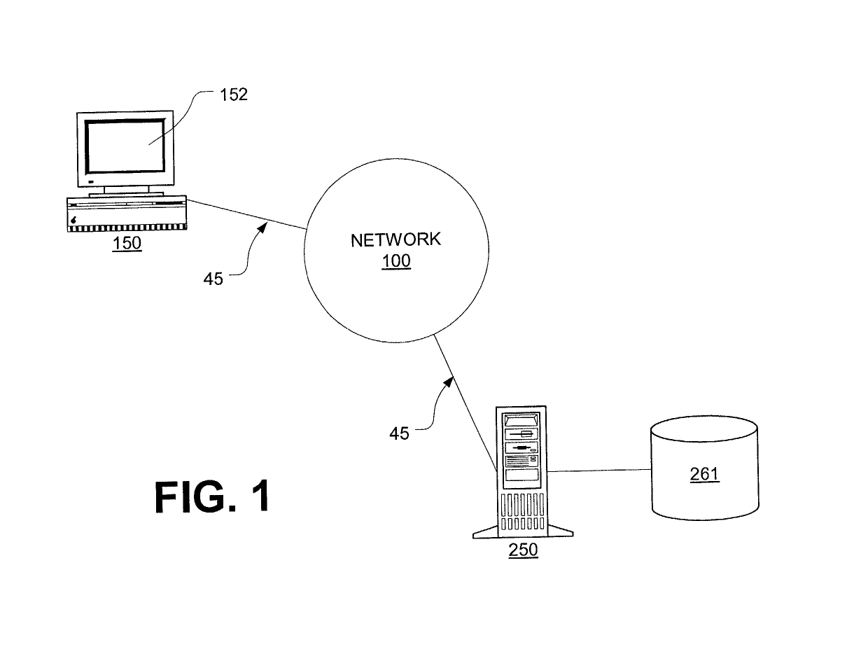

FIG. 1 illustrates an embodiment of the data survey collection system of the present invention. There is shown a client-side terminal 150. Client-side terminal 150 includes a display device 152 and a network interface 45. Client-side terminal 150 is connected to network 100 via network interface 45. A database server 250 is provided for receiving survey data and updating data stored in survey database 261.

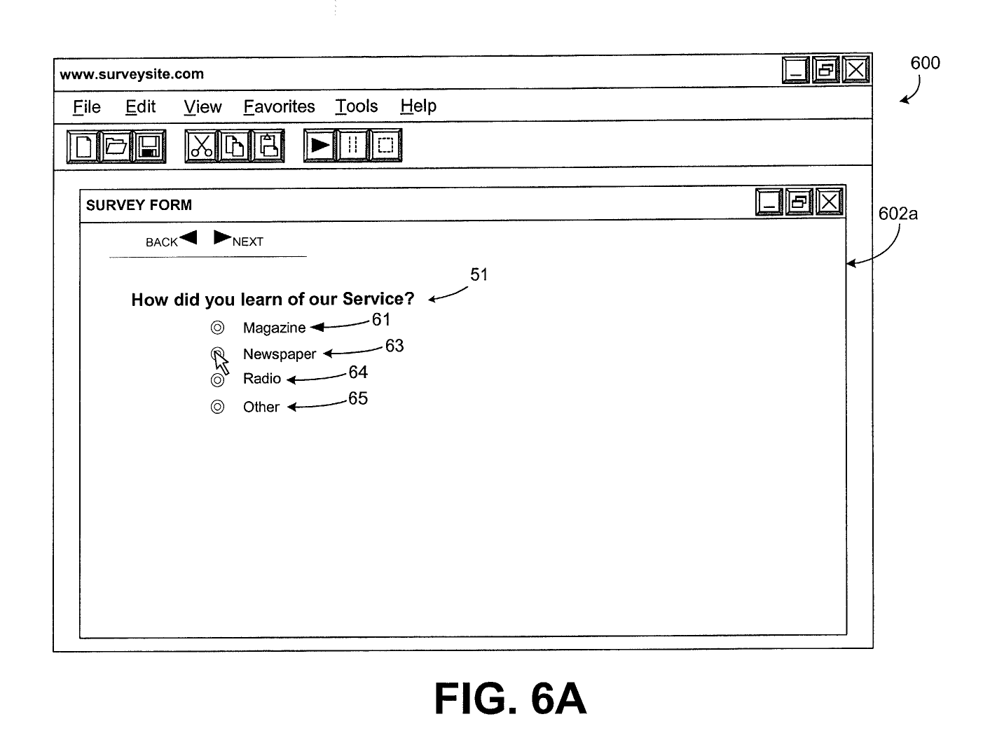

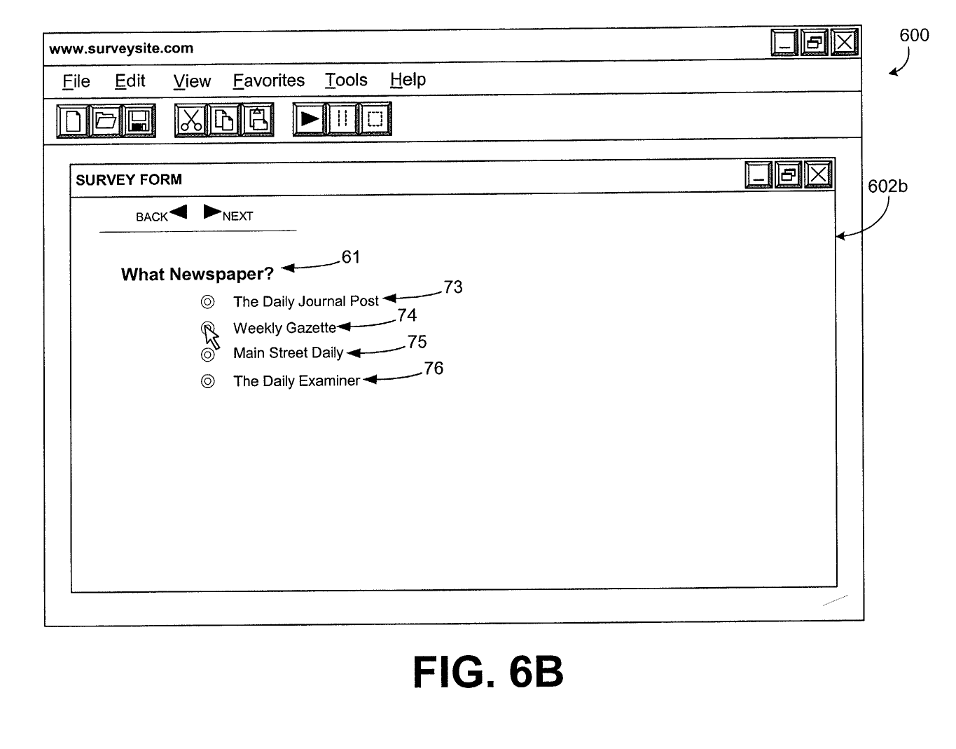

With additional reference to FIG. 6A or FIG. 6B, client-side terminal 150 is used to present a survey form 602a or 602b to a survey participant via a graphical user interface (GUI) 600 displayed on display device 152. A survey participant inputs data via client-side terminal 150 in response to the survey form. The data input is then provided to database server 250, which causes the data input to be incorporated into the survey data of database 261. Client-side terminal 150 may be, for example but not limited to, a personal computer, a workstation, an interactive commerce kiosk, a wireless access protocol (WAP) compliant device, or a personal digital assistant (PDA). Further, it will be recognized by those skilled in the art that client-side terminal 150 can be configured so as to include all functional aspects of database server 250 and database 261, thus alleviating any need for a separate database server 250, database 261 or network 100, if so desired.

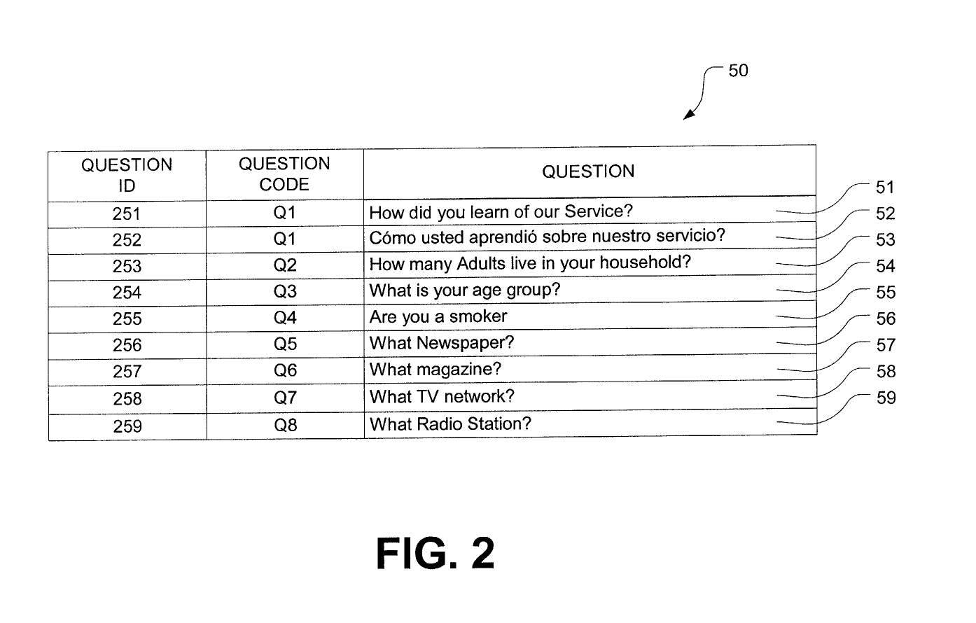

As an example, and with reference to FIG. 2 through FIG. 4, a question 51 associated with the question ID 251 is presented in the data survey. The survey participant will be provided with a predefined list of possible answers corresponding to answer ID's 001, 003, 005, 007 from which they must select one or more of in order to answer the question presented.

FIG. 2 illustrates a question table 50 that contains a predefined list of possible questions 51 through 59 available for presentation in a survey form such as that illustrated in FIG. 6A and FIG. 6B. Question table 50 can be, for example, incorporated as a part of database 261 (FIG. 1). Questions 51 through 59 may be, for example, in multiple languages if desired. Each of these questions 51 through 59 is assigned a question code. If multiple languages are used, the same question code may be assigned to the same question, or, different question codes may be assigned to indicate the use of the different language.

In the example illustrated in FIG. 2, the questions 51 through 59 are assigned a question code from Q1 through Q8. With respect to questions 51 and 52, it will be noted that each of these questions has been assigned the same question code, Q1. Further, it will be noted that question 51 is an English language presentation of the question “How did you learn of our Service?”, while question 52 is the Spanish language presentation of the very same question. Each question, 51 through 59, is also assigned a unique question identification (ID) 251 through 259, respectively. Question 51 is associated with the unique question ID 251, while question 52 is associated with the unique question ID 252.

It will be noted that the question ID may be associated with more than one question, while each question code is associated with only one question. For example, question code Q1 is associated with the question 51 (“How did you learn of our Service?”) which can be presented in English but may also be presented in other languages (preferably separate from presentation in English). Thus, question code Q1 identifies the question presented regardless of the variations of language or phrasing in which the question may be presented. The question ID 251, on the other hand, is unique to question 51 (English) and uniquely identifies the English presentation of the question “How did you learn of our Service?”

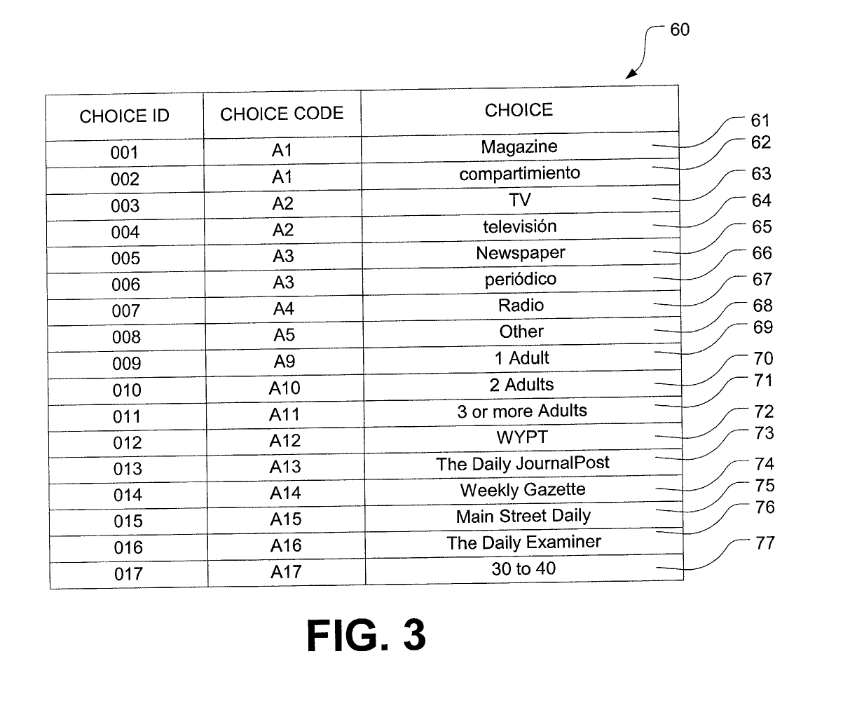

FIG. 3 illustrates a choice table 60, which sets out potential answers (choices) to questions presented in a survey form. The choices set out in choice table 60 coincide with questions set out in question table 50 (FIG. 2). Choice table 60 is preferably incorporated as a part of database 261 (FIG. 1).

In choice table 60, a number of choices, 61 through 77, are provided. Each choice, 61 through 77, is associated with a choice code, Althrough A17. Further, each choice is associated with a unique choice ID code 001 through 017, respectively. In the case of the choice 61, “Magazine,” the unique choice code Al is associated therewith. Likewise, for the choice 77, the unique choice code A17 is associated therewith.

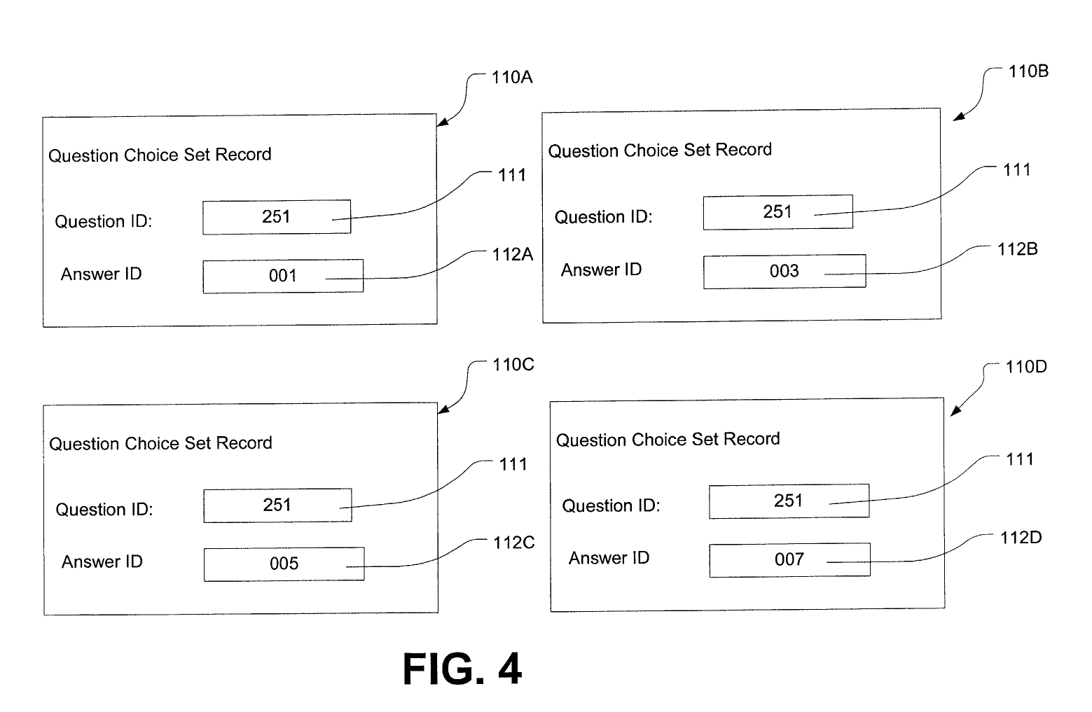

FIG. 4 illustrates a series of question choice set records 110A through 110D. These question choice set records define an answer set for a particular question, in this case, the question associated with the question ID 111. Each question choice set record 110A through 110D associates a particular question ID 111 with potential relevant answer IDs 112A through 112D available to a survey participant in responding to the question associated with the question ID 111. More particularly, question choice set record 110A associates a question ID 111 identifying a particular question ID 251, with an answer ID 112A identifying answer ID 001. Question choice set record 110B associates question ID 111 identifying question 251, with an answer ID 112B identifying answer ID 003. Question choice set record 110C associates an answer ID 112C identifying answer ID 005 with the question ID 111 identifying question 251. Likewise, question choice set record 110D associates an answer ID 112D identifying answer ID 007 with the question ID 111 identifying question 251. In this way, the answer IDs 001, 003, 005 and 007, A1 through A4 (FIG. 3) are associated with the question ID 251. Thus, when the question 51 (FIG. 2), associated with the question code Q1 is presented to a survey participant, answers associated with choice codes A1 through A4 (FIG. 3) will be presented to the survey participant in, for example, the language in which question 51 was presented as possible answer selections. With reference to FIG. 1 and FIG. 2, the question choice set record 110 of FIG. 4 specifies that for the question assigned the question code Q1, question 51 (“How did you learn of our Service?”), answers associated with the choice codes A1, A2, A3, A4 and A5, answers 61 through 65 (FIG. 3), respectively (“Magazine,” “TV,” “Newspaper,” “Radio,” and “Other”) are available relevant answer choices.

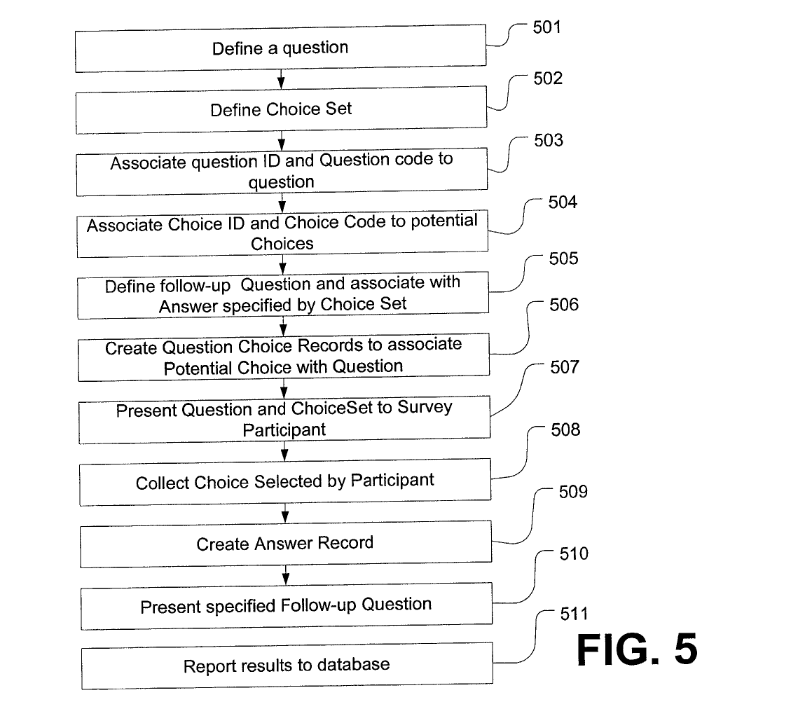

FIG. 5 shows a flowchart illustrating the method of the present invention. A question to be included in a survey is defined (501). Potential answers (choices) that can be selected by a survey participant are defined and established as a choice set (502). A unique question ID is associated with the defined question (503). A unique answer ID is associated with each of the potential answers defined (504). A defined follow-up question is specified for defined potential answers of the established answer set (505). A question choice record set is created which associates the defined question with a set of potential answers (506). The defined question is presented to a survey participant as a part of a survey form along with the set of potential answers based upon the association made via the question choice record set for the question presented (507). The answer choice selected by the survey participant is collected (508) and an answer record is created which associates the selected answer with the defined question presented to the survey participant (509). A specified defined follow-up question, if any, is presented to the survey participant (510). After all survey questions have been presented and answered by the survey participant and relevant answer records have been created, the results represented by the relevant answer records are reported to the database 261 (511).

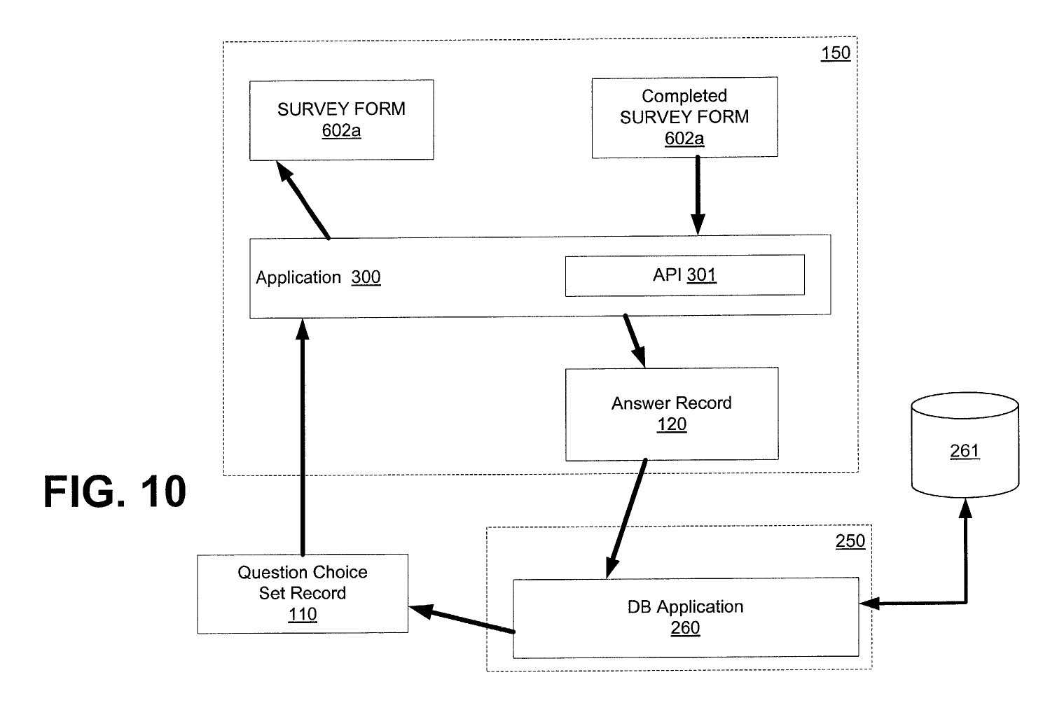

The flow chart of FIG. 5 shows the architecture, functionality, and operation of a possible implementation of the application software 300 (FIG. 10). In this regard, each block represents a module, segment, or portion of code, which comprises one or more executable instructions for implementing the specified logical function(s). It should also be noted that in some alternative implementations, the functions noted in the blocks may occur out of the order noted in FIG. 5. For example, two blocks shown in succession in FIG. 5 may in fact be executed substantially concurrently or the blocks may sometimes be executed in the reverse order, depending upon the functionality involved, as will be further clarified hereinbelow.

Further, any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

FIG. 6A and FIG. 6B illustrate a graphical user interface (GUI) 600, which is displayed on a display device 152 (FIG. 1). GUI 600 is an illustrative example of a possible GUI used to present a visual representation of a survey form 602a and 602b to a survey participant. Survey form 602a includes a question 51 (“How did you learn of our Service?”) as well as a set of relevant potential answer choices 61, 63, 64 and 65. More particularly, for question 51, the relevant potential answers 61, 63, 64 and 65, “Magazine”, Newspaper”, “Radio” and “Other” are presented as choices for selection by a survey participant. Where a survey participant chooses, for example, the choice 63 (“Newspaper”) as shown in FIG. 6A, a follow-up question associated with the choice 63 is subsequently presented to the survey participant.

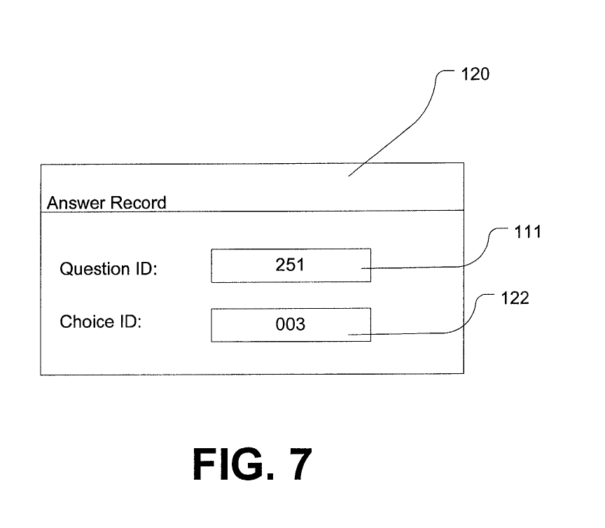

With reference to FIG. 7, a possible illustrative answer record 120 is shown. An answer record 120 is generated each time a survey participant completes a selection of an answer to a question presented via survey form 602a or 602b (FIGS. 6A and 6B). Answer record 120 associates a question ID 111 representing a question presented to a survey participant, with a selected choice ID 122 representing an answer selected by a survey participant in response to the question presented. In this example, answer record 120 associates a question ID 111 with a selected choice ID 122. Here, the selected choice ID 122 specifies the choice ID 003, the choice that was selected by the survey participant in response to the question specified by the question ID 251. More particularly, and with reference to FIG. 2, FIG. 3 and FIG. 7, answer record 120 indicates that for the question associated with the question code 251 (the English presentation of the question “How did you learn of our Service?”), the survey participant has selected an answer having the choice ID 003 associated with it. With reference to FIG. 3, it can be seen that the English presentation of the response “TV” is associated with the choice ID 003. Answer record 120 is then provided to the database server 251, which in turn causes the response “TV” to be tallied as a part of the survey results.

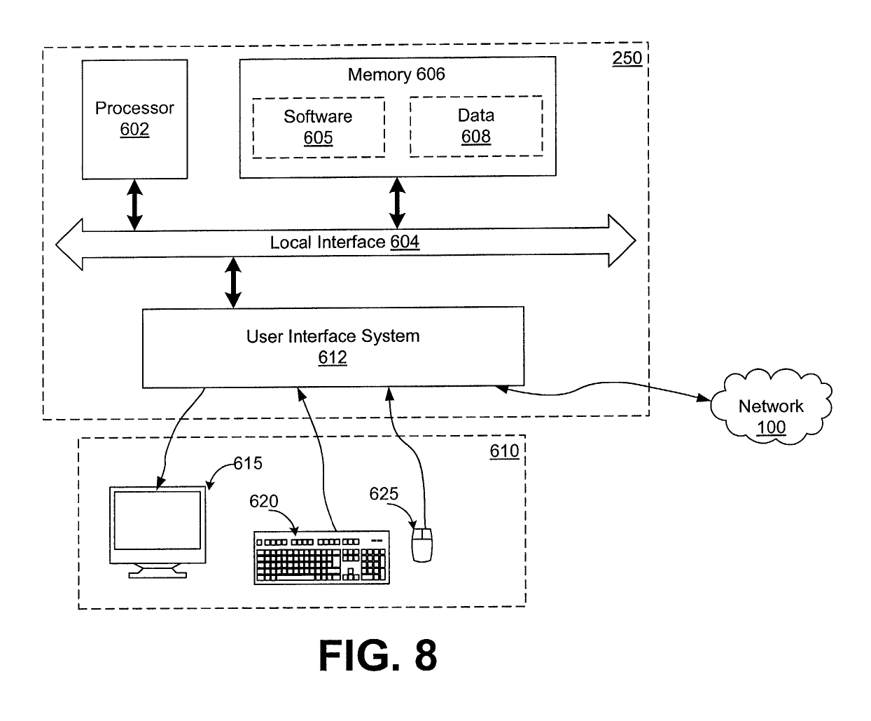

FIG. 8 illustrates one embodiment of a database server 250 which is set up to interface with a client-side terminal 150 via network 100 (FIG. 1). There is provided a processor 602, a local interface bus 604, a storage memory 606 for storing electronic format instructions (software) 605 and data 608, which includes database 261 (FIG. 1). Further, storage memory 606 can include both volatile and non-volatile memory. An input/output interface 612 is provided for interfacing with, for example, the network 100, a display 615, and input devices such as a keyboard 620 and pointing device 625. Processor 602 controls and grants access to the data stored in memory 606 and database 261 (FIG. 1) in accordance with the instructions stored on memory 606. Further, processor 602 controls the execution of instructions stored on storage memory 606. The electronic instructions (software) 605 necessary to receive survey data and incorporate it into database 261 (FIG. 1) are preferably stored on memory 606. Presentation server 250 (FIG. 1) may be configured so as to receive input via the user input interface 610. User input interface may include devices such as keyboard 620 and pointing device 625. There may also be provided a display device 615.

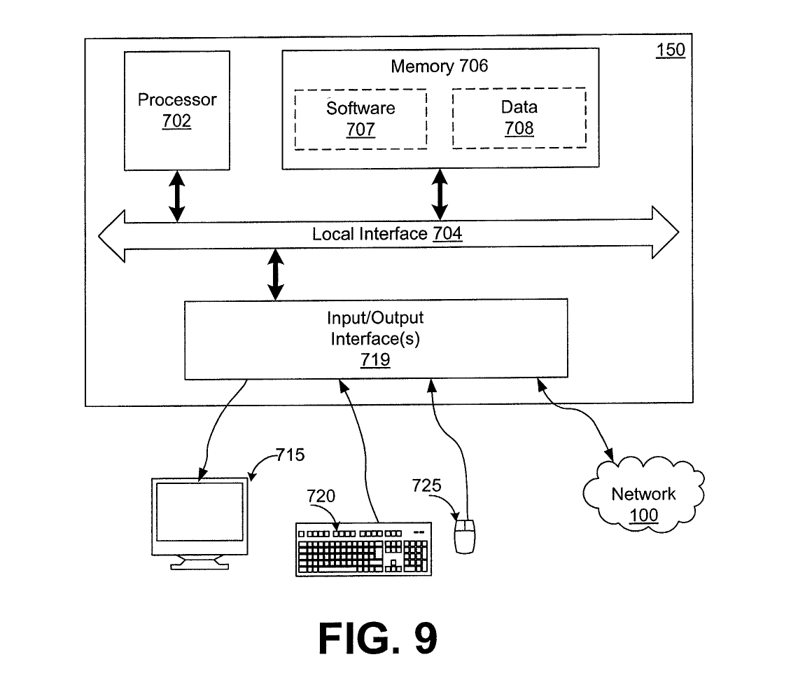

With reference to FIG. 9, a block diagram of one embodiment of a personal client-side terminal 150 is shown. It can be seen that there is provided a processor 702, a local interface bus 704, a storage memory 706 for storing electronic format instructions (software) 707 and data 708. Further, storage memory 706 can include both volatile and non-volatile memory. An input/output interface 719 is provided for interfacing with, for example, the network 100, a display 715, and input devices such as a keyboard 720 and pointing device 725. Processor 702 controls and grants access to the data stored in memory 706 in accordance with the electronic format instructions stored on memory 706. Further, processor 702 carries out the function of generating and displaying on, for example, display device 715, a GUI presentation of a survey form 602a/602b (FIG. 6A and FIG. 6B) in accordance with electronic format instructions (software) stored on storage memory 706. Display device 715 may be, for example, a touch screen display or the like.

With reference to FIG. 10, a diagram of the system and method of the present invention is shown. There is an application 300, which includes an application-programming interface API 301. Application 300 may be, for example, an e-commerce application which incorporates a database connectivity interface such as, for example, a Java database connectivity (JDBC) interface. With reference to FIG. 9, application 300 may be installed and run on client-side terminal 150 or downloaded from database server 250 (FIG. 1) as, for example, an applet. In this regard, application 300 may be stored on storage memory 706 as electronic format instructions 707. Application 300 causes a series of survey forms 602a to be generated which incorporate questions and relevant choice sets to be presented to a survey participant on, for example, a display device 152 (FIG. 1). Once the survey participant has completed answering the questions presented, application 300 causes one or more answer records 120 to be created. These answer records 120 are then provided to the database application 260 which, in turn, causes the data survey database 261 to be updated to include the survey data collected.

Database system software 250 is, for example, an Oracle™ database package with Java Database Connectivity (JDBC) interface, or Microsoft Object Oriented Database Connectivity (MS ODBC) interface. JDBC is an application programming interface (API) for linking Java™ programs to a database system. JDBC allows linking of a Java based program to a database utilizing the JDBC interface. The API 301 of application 300 determines for the question presented to a survey participant, what answer is chosen (selected) by the survey participant via input through user input devices 720 or 725 (FIG. 9), for example. The API 301 then causes a data object (answer record 120) to be created which specifies the choice ID associated with the chosen answer and the question ID of the question presented. In turn, application 300 generates a data object (choice record 120-FIG. 7) that associates the question ID 251 of the presented question 51 (FIG. 2) with choice ID 003 of the selected choice 61 (FIG. 3).

Answer record 120 is then forwarded to database software 250 which in turn causes the database 261 to be updated in accordance with answer record 120 to reflect the answer selected in response to the question presented.

The data collection system of the present invention can be implemented in hardware, software, firmware, or a combination thereof. In the preferred embodiment(s), the data collection system and method is implemented in software or firmware that is stored in a memory and that is executed by a suitable instruction execution system. If implemented in hardware, as in an alternative embodiment, the data collection system and method can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The application software 300 (FIG. 10), which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note, that the computer-readable medium could even be paper or another suitable medium, upon which the program is printed, as the program can be electronically captured, via for instance, optical scanning of the paper or other medium, then compiled, interpreted or otherwise processed in a suitable manner, if necessary, and then stored in a computer memory.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed:

1. A method of collecting survey data comprising the steps of:
defining a question for presentation in a survey;
defining a plurality of potential answers, each one of said plurality of potential answers corresponding to said question;
assigning a question code to said question;
assigning a plurality of choice codes, one of each said choice code assigned uniquely to each one of said plurality of potential answers;
creating question choice records for associating question code with each choice code;
presenting said question to a survey participant; and
presenting said set of potential answers to said survey participant in accordance with said question choice records.

2. The method of claim 1, further comprising the steps of:
creating an answer record to associate said choice code of a selected answer with said question code.

3. The method of claim 1, further comprising the step of assigning a choice type to said choice code to define the format of the answer solicited by said question.

4. The method of claim 3, wherein said format comprises a multiple-choice format to capture user entered numeric or text data in support of an “other” choice.

5. The method of claim 1, further comprising the step of specifying a follow-up question for a predetermined said potential answer.

6. The method of claim 5, further comprising the step of presenting said follow-up question to survey participant.

7. A system for collecting survey data comprising:
a display device for presenting a question to a survey participant; and
a controller for presenting a plurality of potential answers to said question to said survey participant in accordance with a question choice record.

8. A system according to claim 7, wherein said question is associated with a unique question ID and a question code.

9. A system according to claim 7, wherein each of said plurality of potential answers are associated with a unique choice ID and a choice code.

10. A system according to claim 7, wherein said question choice record associates said unique question ID with said unique answer ID.

11. A system according to claim 7, wherein said display device and said controller constitute a client-side terminal.

12. A system according to claim 11, wherein said client-side terminal comprises a personal digital assistant (PDA).

13. A system according to claim 14, wherein said question choice record is received from a database collection server.

14. A system according to claim 7, wherein said controller causes an answer record to be generated where said survey participant responds to said question via selected one of said plurality of choices.

15. A system for collecting survey data comprising:
a database server comprising a database for storing survey data;
an interface for receiving an answer record from a client-side terminal; and
a controller for updating said database in accordance with said answer record.

16. A system for collecting survey data according to claim 15, wherein said interface comprises a network interface for connecting to a network.

17. A system for collecting survey data according to claim 15, wherein said network interface comprises a wireless network interface.

18. A system for collecting survey data comprising:
storage memory for storing data and electronic format instructions;
logic stored on said storage memory for defining a question for presentation in a survey;
logic stored on said storage memory for defining a set of potential answers to said question, said set comprising a plurality of relevant potential answers to said question;
logic stored on said storage memory for assigning a question code to said question;
logic stored on said storage memory for assigning a choice code to each of said plurality of potential answers;
logic stored on said storage memory for creating question choice records for associating question ID with each choice ID;
logic stored on said storage memory for presenting said question to a survey participant; and
logic stored on said storage memory for presenting said set of potential answers to said survey participant in accordance with said question choice records.

19. A system for collecting survey data comprising:
storage means for storing data and electronic format instructions;
means for defining a question for presentation in a survey;
means for defining a set of potential answers to said question, said set comprising a plurality of relevant potential answers to said question;
means for assigning a question code to said question;
means for assigning a choice code to each of said plurality of potential answers;
means for creating question choice records for associating question ID with each choice ID;
means for presenting said question to a survey participant; and
means for presenting said set of potential answers to said survey participant in accordance with said question choice records.
